(19) United States
(12) Patent Application Publication
(10) Pub. No.: US 2025/0227189 A1
(43) Pub. Date: Jul. 10, 2025

(54) IMAGE PROCESSING APPARATUS, READING DEVICE, IMAGE FORMING APPARATUS, IMAGE PROCESSING METHOD, AND RECORDING MEDIUM

(71) Applicants: Tadaaki OYAMA, Kanagawa (JP); Masamoto NAKAZAWA, Kanagawa (JP); Ayumu HASHIMOTO, Kanagawa (JP)

(72) Inventors: Tadaaki OYAMA, Kanagawa (JP); Masamoto NAKAZAWA, Kanagawa (JP); Ayumu HASHIMOTO, Kanagawa (JP)

(21) Appl. No.: 18/853,756

(22) PCT Filed: Apr. 7, 2023
(86) PCT No.: PCT/IB2023/053565

§ 371 Date: Oct. 3, 2024

(30) Foreign Application Priority Data
Apr. 27, 2022 (JP) 2022-073501

(51) Int. Cl. H04N 1/40; H04N 1/48; H04N 1/60; H04N 23/11; H04N 23/56

(52) U.S. Cl. CPC H04N 1/40056; H04N 1/486; H04N 1/6002; H04N 23/11; H04N 23/56; H04N 2201/0094

(57) ABSTRACT

An image processing apparatus includes: a light source to irradiate an object with at least invisible light: an image sensor having sensitivity to a visible light wavelength range and an invisible light wavelength range: an image processor to generate an image according to image information that is output by the image sensor: a switching unit to switch the image processor to a single-color image generation mode in which a single-color image is generated. the single-color image being an image of a single color: and a controller to control the switching unit to switch the image processor to the single-color image generation mode in response to selection of an operating mode in which the invisible light is emitted.

### TECHNICAL FIELD

Embodiments of the present disclosure relate to an image processing apparatus, a reading device, an image forming apparatus, an image processing method, and a recording medium.

### BACKGROUND ART

As known in the art, a latent image that cannot be recognized under visible light is formed on some public certificates, for example. A reading device that emits invisible light such as infrared light reads a document on which a latent image is formed, whereby the latent image is perceptible to the naked human eye in an image that is output from the reading device. Thus, authenticity is checked.

PTL 1 discloses a technology for solving difficulty in viewing an infrared image in a night imaging mode of a monitoring camera. The disclosed technology enhances visual recognizability of an image by combining an infrared light image and a visible color image.

### Citation List

### Patent Literature

### [PTL 1]

Japanese Patent No. 6243087

### SUMMARY OF INVENTION

### Technical Problem

However, since an image generation mode using visible light is typically selected, a setting for generating an image has to be changed each time an image output using invisible light is performed. When the image output using invisible light is performed without changing the setting, an image processing is performed with a color setting of a case using visible light. In this case, there is a drawback that the appearance of the output image is unnaturally colored differently from the appearance of an original of an object, and a person checking the output image feels strange.

In light of the above, an object of the present disclosure is to provide an image processing apparatus, a reading device, an image forming apparatus, and an image processing method that enable selection of an image generation mode according to a coloring of an original of an object when a setting is configured to use invisible light.

### Solution to Problem

An embodiment of the present disclosure includes an image processing apparatus. The image processing apparatus includes a light source to irradiate an object with at least invisible light; an image sensor having sensitivity to a visible light wavelength range and an invisible light wavelength range; an image processor to generate an image according to image information that is output by the image sensor; a switching unit to switch the image processor to a single-color image generation mode in which a single-color image is generated, the single-color image being an image of a single color; and a controller to control the switching unit to switch the image processor to the single-color image generation mode in response to selection of an operating mode in which the invisible light is emitted.

An embodiment of the present disclosure includes a reading device. The reading device includes a scanner including the light source and the image sensor of the above-described image processing apparatus.

An embodiment of the present disclosure includes an image forming apparatus. The image forming apparatus includes a scanner including the light source and the image sensor of the above-described image processing apparatus; and an image forming section to form an image according to an output image output from the image processor.

An embodiment of the present disclosure includes an image processing method. The image processing method includes irradiating an object with at least invisible light; outputting image information of the object from an image sensor having sensitivity to a visible light wavelength range and an invisible light wavelength range; generating an image according to the image information that is output from the image sensor; and switching to a single-color image generation mode in which a single-color image is generated, in response to selection of an operating mode in which the invisible light is emitted, the single-color image being an image of a single color.

An embodiment of the present disclosure includes a recording medium storing a program storing instructions which, when executed by one or more processors of a computer, causes the one or more processors to perform an image processing method. The method includes irradiating an object with at least invisible light; outputting image information of the object from an image sensor having sensitivity to a visible light wavelength range and an invisible light wavelength range; generating an image according to the image information that is output from the image sensor; and switching to a single-color image generation mode in which a single-color image is generated, in response to selection of an operating mode in which the invisible light is emitted, the single-color image being an image of a single color.

### Advantageous Effects of Invention

According to one or more embodiments of the present disclosure, in a case that a setting of using invisible light is configured, an image generation mode suitable for coloring of an original of an object is selected.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a block diagram illustrating an example of a configuration of an image processing apparatus, according to Embodiment 1 of the present disclosure.

FIG. 2 is a graph illustrating an example of spectral sensitivity characteristics of a typical silicon image sensor.

FIG. 3A to FIG. 3E are diagrams illustrating an example of comparison between an output image in a multicolor image generation mode and an output image in a single-color image generation mode, according to an embodiment of the present disclosure.

FIG. 4 is a flowchart illustrating an example of an image processing performed by the image processing apparatus, according to an embodiment of the present disclosure.

FIG. 5 is a diagram illustrating a configuration of a reading device, according to an example.

FIG. 6 is a graph illustrating an example of spectral reflection characteristics of general paper and a reference white plate.

FIG. 7 is a block diagram illustrating an example of the reading device, according to Modification 1 of the example.

FIG. 8 is a flowchart illustrating an example of an image processing flow performed by the reading device, according to Modification 1 of the example.

FIG. 9A to FIG. 9F are diagrams illustrating an example of comparison between a case where background correction processing is included and a case where background correction processing is not included, according to Modification 1 of the example.

FIG. 10 is a block diagram illustrating an example of a configuration of the reading device, according to Modification 2 of the example.

FIG. 11 is a flowchart illustrating an example of an image processing flow performed by the reading device, according to Modification 2 of the example.

FIG. 12A, FIG. 12B, and FIG. 12C are diagrams for describing print correction processing, according to Modification 2 of the example.

FIG. 13 is a graph illustrating a relation between spectral sensitivity characteristics (FIG. 2) of a typical silicon image sensor and emission profile characteristics of a near-infrared (NIR) light source.

FIG. 14 is a block diagram illustrating an example of a configuration of the reading device, according to Modification 3 of the example.

FIG. 15 is a flowchart illustrating an example of an image processing flow performed by the reading device, according to Modification 3 of the example.

FIG. 16 is a graph illustrating the spectral sensitivity characteristics (FIG. 2) of a red (R) pixel, a green (G) pixel, and a blue (B) pixel and spectral sensitivity characteristics of an infrared (IR) pixel.

FIG. 17 is a block diagram illustrating an example of a configuration of the reading device, according to Modification 4 of the example.

FIG. 18 is a block diagram illustrating an example of a configuration of the reading device, according to Modification 5 of the example.

FIG. 19 is a flowchart illustrating an example of an image processing flow performed by the reading device, according to Modification 5 of the example.

FIG. 20A, FIG. 20B, and FIG. 20C are diagrams illustrating an example of comparison between an output image in a case of performing background correction processing using a correction value and an output image in a case of performing background correction without using a correction value, according to Modification 5 of the example.

FIG. 21 is a flowchart illustrating an example of an image processing flow performed by the reading device, according to Modification 6 of the example.

FIG. 22A, FIG. 22B, and FIG. 22C are diagrams illustrating an example of comparison between a single-color multilevel image and a single-color binary image, according to Modification 6 of the example.

FIG. 23 is a flowchart illustrating an example of an image processing flow performed by the reading device, according to Modification 7 of the example.

FIG. 24A. FIG. 24B, and FIG. 24C are diagrams illustrating an example of comparison between a single-color multilevel image and a single-color binary image, according to Modification 7 of the example.

FIG. 25 is a flowchart illustrating an example of an image processing flow performed by the reading device, according to Modification 8 of the example.

FIG. 26 is a schematic view illustrating a configuration of an image forming apparatus according to Embodiment 2.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of an image processing apparatus, a reading device, an image forming apparatus, and an image processing method are described in detail with reference to the accompanying drawings.

### Embodiment 1

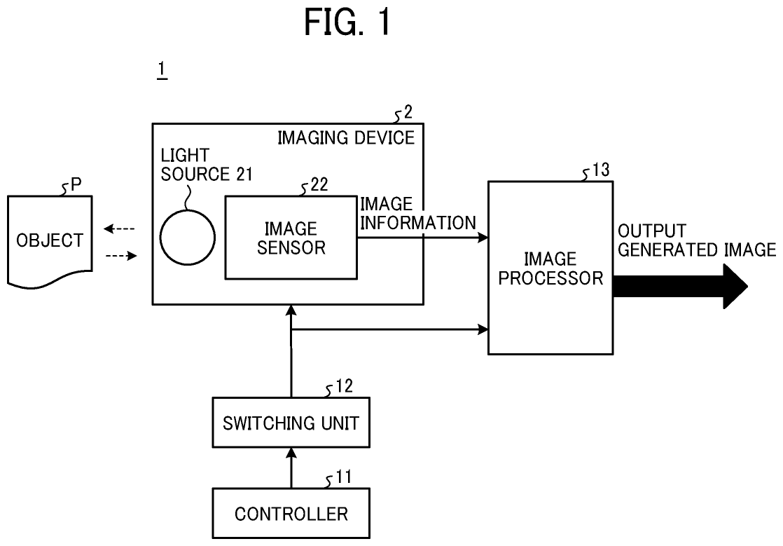

FIG. 1 is a diagram illustrating an example of a configuration of an image processing apparatus 1 according to Embodiment 1. The image processing apparatus 1 illustrated in FIG. 1 includes a controller 11, a switching unit 12, and an image processor 13. The controller 11 and the switching unit 12, and the switching unit 12 and the image processor 13 are connected to each other by a signal line, for example. An imaging device 2 may be mounted on a substrate of the image processing apparatus 1 or may be connected to an external terminal of the image processing apparatus 1 via a communication cable.

The imaging device 2 includes a light source 21 and an image sensor 22. The light source 21 includes a light source that can irradiate an object P with at least invisible light. The light source 21 may include a light source that irradiates the object P with visible light. The image sensor 22 is an image sensor such as a charge-coupled device (CCD) or a complementary metal oxide semiconductor (CMOS) that is sensitive to a visible light wavelength range and an invisible light wavelength range. The description is given of an example in which an image sensor including pixels of three colors of a red (R) pixel, a green (G) pixel, and a blue (B) pixel for explanatory convenience, this is just an example. Any suitable image sensor is applicable provided that it includes pixels of at least two colors.

In response to receiving a request signal to start imaging from the controller 11, the imaging device 2 starts imaging in a designated operating mode and transmits image information to the image processor 13. The image processor 13 performs image processing in an image generation mode corresponding to the operating mode of the imaging device 2 on the basis of the image information that is output from the imaging device 2.

The operating mode of the imaging device 2 includes a first operating mode for outputting visible image information and a second operating mode for outputting invisible image information. The visible image information is image information that is output in response to receiving, by the image sensor 22, reflected light from the object P under visible light. The invisible image information is image information that is output in response to receiving, by the image sensor 22, reflected light from the object P under invisible light.

As an example, in the first operating mode, the imaging device 2 images the object P with the invisible light of the light source 21 off, and outputs the visible image information of the object P from the image sensor 22. When the light source 21 includes a visible light source, lighting of visible light is turned on. Further, in the second operating mode, the imaging device 2 images the object P with the invisible light of the light source 21 on, and outputs the invisible image information of the object P from the image sensor 22. When the light source 21 includes a visible light source, lighting of visible light is turned off.

The image generation mode of the image processor 13 includes multiple image generation modes. As an example, the image processor 13 includes a multicolor image generation mode and a single-color image generation mode. The multicolor image generation mode is an image generation mode in which visible image information of multiple colors from the imaging device 2 is multiplied by a coefficient for correcting a variation in sensitivity between the colors, thereby an output image of the multiple colors is generated. Examples of the multicolor image generation mode include a color image generation mode in which an RGB color image is generated. The single-color image generation mode is an image generation mode in which an output image of a single color of the object P is generated.

The controller 11 receives an operation instruction from an operation unit used by, for example, a user to configure settings. The controller 11 receives an imaging start instruction and an operating mode from the operation unit, and transmits signals respectively corresponding to the imaging start instruction and the operating mode to the imaging device 2. The switching unit 12 detects whether the signal transmitted from the controller 11 to the imaging device 2 is an instruction for the second operating mode. In response to detecting the instruction of the second operating mode, the switching unit 12 transmits a signal for switching the image generation mode to an image generation mode corresponding to the second operating mode to the image processor 13. For example, when a default setting of the image generation mode of the image processor 13 is the multicolor image generation mode, the multicolor image generation mode is switched to the single-color image generation mode.

The image processor 13 applies the setting of the multicolor image generation mode or the single-color image generation mode to the image information output from the image sensor 22, and outputs a generated image to which the setting is applied as an output image.

### Regarding Difference Between Multicolor Image Generation Mode and Single-color Image Generation Mode

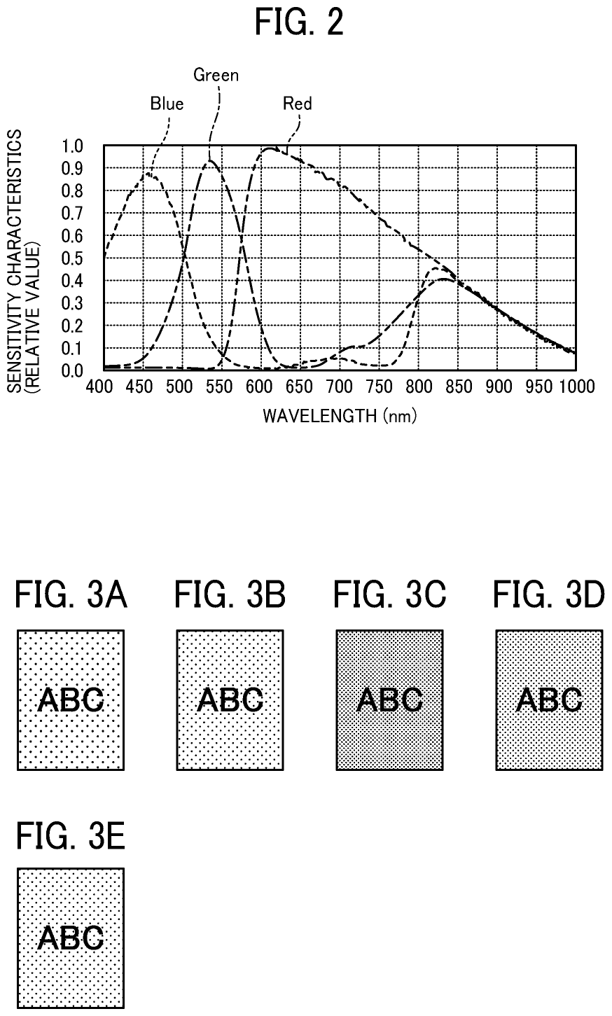

FIG. 2 is a graph illustrating an example of spectral sensitivity characteristics of a typical silicon image sensor. The spectral sensitivity characteristics of FIG. 2 illustrates comparison spectral sensitivities of an R pixel, a G pixel, and a B pixel. Since R, G, and B have characteristic curves of different shapes, variations in sensitivity occur between the colors when visible light is received. Therefore, even when the amount of light is the same, values obtained by electrical conversion are different between the colors.

In the first operating mode, a setting of the multicolor image generation mode is applied to the image processor 13. Accordingly, visible image information of each of the colors is multiplied by a coefficient for correcting variation in sensitivity between the colors to generate output images of the colors.

As a result, the variation in the sensitivity between the color is corrected, and an image obtained by combining the output images of the colors is reproduced with colors close to the original.

As illustrated in FIG. 2, a typical silicon image sensor is sensitive not only to a visible light wavelength range (a wavelength of approximately 400 nm to 780 nm) but also to an invisible light wavelength range (e.g., a wavelength of 780 nm or more). In the invisible light wavelength range, the characteristic curves of an R pixel, a G pixel, and a B pixel substantially overlap each other, and there is almost no variation in sensitivity between the colors. For this reason, when the image processor 13 performs the variation correction on invisible image information in the same manner as in visible light with the setting of the multicolor image generation mode, an output image with unnatural coloring different from the appearance of the original is generated. For example, G among RGB is emphasized, and therefore an output image is greenish as a whole. Such the output image gives strange feelings when compared with the original.

FIG. 3A to FIG. 3E are diagrams illustrating an example of comparison between an output image in the multicolor image generation mode and an output image in the single-color image generation mode. FIG. 3A to FIG. 3D illustrate examples of output images in a case that the multicolor image generation mode is applied to invisible image information. FIG. 3E illustrates an example of an output image in a case that the single-color image generation mode is applied to invisible image information.

When an image captured under visible light is output, a coefficient for correcting variation in sensitivity between colors of the image sensor 22 is determined for R image information, G image information, and B image information output from the image sensor 22, and the determined coefficient is applied. On the other hand, in a case of outputting an image captured under invisible light, when the output image is generated in the multicolor image generation mode, the coefficient that is effective in a visible light wavelength range is applied. Since the coefficient is not effective an invisible image, G is emphasized compared to R and B. for example. In such a case, as illustrated in FIG. 3D, the output image is colored in green, which is different from an original.

On the other hand, in a case of outputting an image captured under invisible light, when the mode is switched to the single-color image generation mode, the output image is not colored. FIG. 3E illustrates, as a single-color image, a monochrome image generated from, for example, G image information. Since R image information and B image information are not used, the output image is generated as a monochrome image, thereby an image that gives no strange feelings is obtained, compared with an original.

Further, in a case that an output image is stored in a storage device, since the output image is a single-color image as illustrated in FIG. 3E instead of a composite image including images of a plurality of colors as illustrated in FIG. 3D, there is also an advantage that a data amount is about one third.

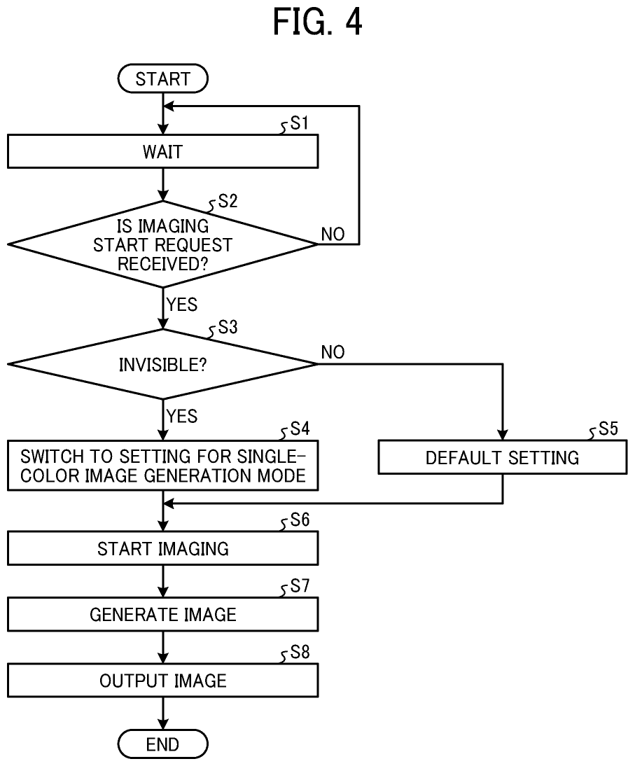

FIG. 4 is a flowchart illustrating an example of an image processing performed by the image processing apparatus 1. First, the controller 11 waits until a request to start imaging is received from the operation unit (step S1). It is assumed that the imaging device 2 is also in a standby state until the request to start imaging is received.

When no request to start imaging is received (step S2: No), the controller 11 keeps the standby state of step S1. In response to receiving the request to start imaging (step S2: Yes), the controller 11 transmits an imaging start signal to the imaging device 2 via the switching unit 12. The switching unit 12 detects whether the signal transmitted from the controller 11 is a second imaging start signal indicating that imaging is to be started in the second operating mode, in other words, a mode for outputting invisible image information (step S3).

In response to detecting that the imaging start signal transmitted by the controller 11 is the second imaging start signal (step S3: Yes), the switching unit 12 transmits a signal for switching to the single-color image generation mode to the image processor 13, to switch a mode of the image processor 13 from the multicolor image generation mode, which is set by default, to the single-color image generation mode (step S4).

When the imaging start signal transmitted by the controller 11 is not the second imaging start signal (step S3: No), the switching unit 12 keeps the default setting without switching the setting of the image processor 13 (step S5).

The imaging device 2 starts imaging in the operating mode corresponding to the request signal transmitted from the switching unit 12 after the setting of the image processor 13 (step S6). The image processor 13 applies the default image generation mode or the switched image generation mode to image information that is output from the imaging device 2 to generate an image (step S7), and outputs the generated image as an output image (step S8).

An output destination to which the output image is to be output may be any desired location determined according to a configuration. Examples of the output destination include a display or a storage device. In another example, in a case that a printing mechanism for printing on a paper medium is provided, the output destination may be a printing device.

As described above, when the operating mode of the imaging device 2 is the second operating mode for an invisible image, the image processing apparatus 1 automatically switches the setting of the image processor 13 to a setting for obtaining an output image corresponding to the second operating mode. Thus, even when the imaging device 2 operates in the second operating mode, an image that does not give strange feelings is obtained as compared with an original.

The image processing apparatus described in the present embodiment is applicable to a reading device. Further, the image processing apparatus can be applied not only to a reading device but also to an in-vehicle camera, for example. An example in which the image processing apparatus is applied to a reading device is described below. In the following description, differences from the embodiment are described, and redundant descriptions that are described in the embodiment are omitted as appropriate.

### Example of Embodiment 1

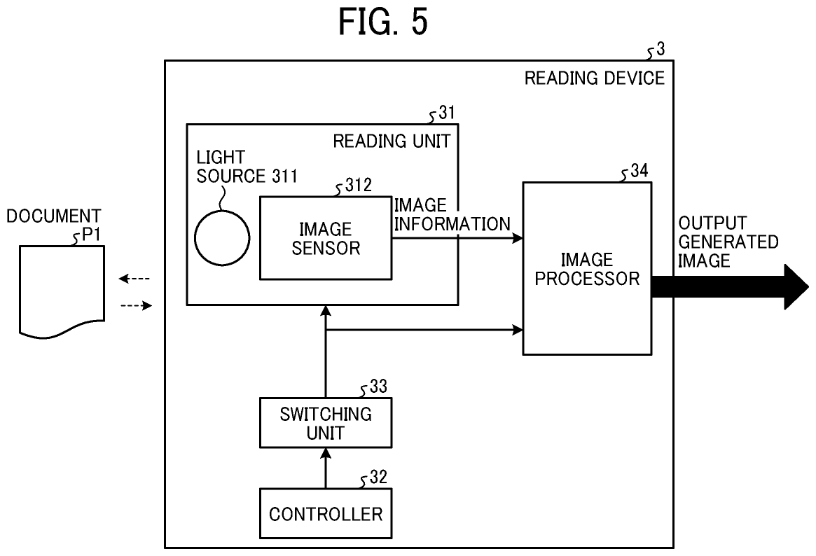

FIG. 5 is a diagram illustrating a configuration of a reading device 3 according to an example. The reading device 3 is a scanner. As illustrated in FIG. 5, the reading device 3 includes a reading unit 31, a controller 32, a switching unit 33, and an image processor 34. The reading unit 31 corresponds to the imaging device 2. A light source 311 corresponds to the light source 21. An image sensor 312 corresponds to the image sensor 22. The controller 32 corresponds to the controller 11. The switching unit 33 corresponds to the switching unit 12. The image processor 34 corresponds to the image processor 13.

An object to be read by the reading unit 31 is a document P1. The document P1 is, for example, a public certificate such as a certificate of residence. Some public certificates include latent image information for determining authenticity. A description is given of one example in which the document P1 is such the document. A document such as a public certificate is just one example. The document P can be any other suitable document, provided that the document includes visible information that is perceptible to the naked human eye under visible light and latent image information that can be checked on an image obtained by reading the document with the document being irradiated by invisible light.

Most latent image information such as public certificates can be read by infrared light. Infrared light is just one example of invisible light. As invisible light, light in a short wavelength range such as ultraviolet or X-ray may be applied.

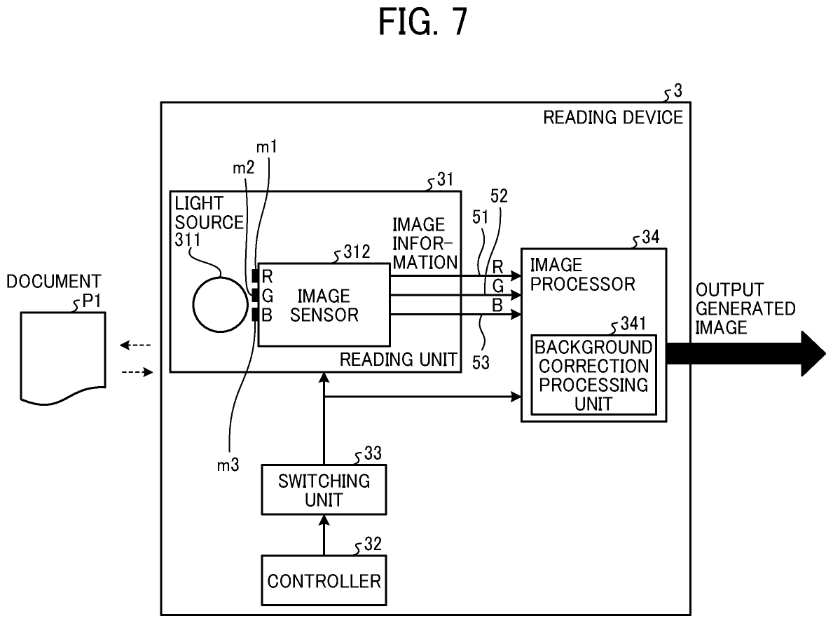

A typical image sensor also has sensitivity in a near infrared region (approximately from 750 nm to near 1100 nm) (see FIG. 2). For this reason, the present example can be applied to a reading device of the related art that uses a typical silicon image sensor having pixel sensors of an R pixel m1, a G pixel m2, and a B pixel m3 as illustrated in FIG. 7.

The R pixel m1 of the image sensor 312 reads light in an R wavelength range, under visible light, to output visible image information as R image information 51. The G pixel m2 reads light in a G wavelength range under visible light, to output visible image information as G image information 52. The B pixel m3 reads light in a B wavelength range under visible light, to output visible image information as B image information 53. Under invisible light, the R pixel m1, the G pixel m2, and the B pixel m3 read light in an invisible light wavelength range, to output invisible image information as the R image information 51, the G image information 52, and the B image information 53, respectively. The image information items are transmitted to the image processor 34. The image processor 34 generates an output image with the setting of the multicolor image generation mode or the single-color image generation mode. The output image that is output by the image processor 34 may be output to, for example, a display or a storage device of the reading device 3. Alternatively, the output image may be output from an external output terminal to an external device.

In the reading device 3 of the example, the image sensor 312 having the RGB pixels acquires image information of three colors under visible light and combines the acquired image information, to obtain a color output image. In other words, the reading device 3 of the example can be used as a color scanner and a monochrome scanner. Further, since the reading device 3 has a light source of invisible light and can output invisible image information, the reading device can also be used as an invisible light scanner used for special purposes. The single reading device 3 can be used as being switched between a color scanner, a monochrome scanner, and an invisible light scanner, thus dramatical enhancement in convenience is expected.

### Modification 1 of Example

As Modification 1 of the example, a configuration of a reading device having a background correction unit that corrects a background level of a document is described. Currently, a terminal apparatus provided in a public space such as a convenience store can output a public certificate by use of the Individual Number card called “My Number Card” under the Japan's Social Security and Tax Number System. A certificate that is output by the terminal apparatus provided in such the public space is printed on general paper, while a certificate issued by a government office is printed on a cardboard of thick paper or paper with a colored background pattern. For this reason, some terminal apparatus provided in such the public space has a unique fraud prevention mechanism that embeds information for authenticity determination to a certificate printed on general paper. A latent image is one of the information for authenticity determination embedded in a certificate. The latent image can be read by a reading device using an infrared light source. However, unlike a certificate issued by a government office, there is no strict regulation with regard to paper on which printing is performed by the terminal apparatus provided in the public space. For this reason, even when paper used by the terminal apparatus is white to the naked human eye, when certificates printed by different terminal apparatuses are read by the reading device using infrared light, the backgrounds of output images that are output from the reading device vary in density, such as white or gray, depending on paper used in the terminal apparatuses.

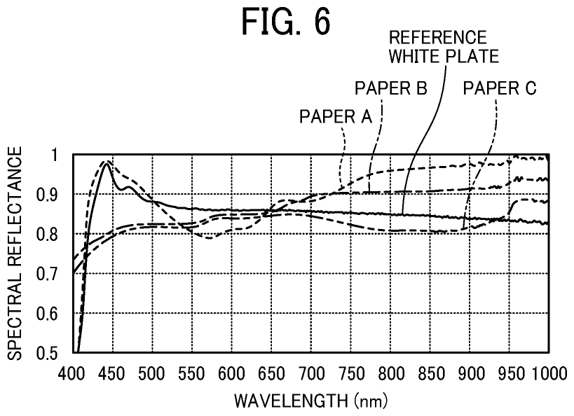

FIG. 6 is a graph illustrating an example of spectral reflection characteristics of general paper and a reference white plate. FIG. 6 illustrates spectral reflection characteristics of three different types of general paper (paper A, paper B, and paper C) that is substantially white to the naked human eye as an example of the general paper.

As illustrated in FIG. 6, although substantially the same white output images are obtained when the reading device reads the three types of general paper with visible light, there is a large difference in spectral reflectance between the paper A, the paper B, and the paper C as illustrated in an infrared wavelength range, when the reading device reads the three types of general paper with infrared light.

For this reason, in an image of a certificate read by the reading device using infrared light, the background may have a density different from the density of the appearance of an original, such as gray. An output image that is output from the reading device having the different background density from the density of an original certificate gives strange feelings as evidence of a stored image.

FIG. 7 is a block diagram illustrating an example of a configuration of the reading device 3 according to Modification 1 of the example. As illustrated in FIG. 7, the image processor 34 of the reading device 3 according to Modification 1 includes a background correction processing unit 341.

Since the image generation mode of the image processor 34 switches from the multicolor image generation mode to the single-color image generation mode in the second operating mode, the background correction processing unit 341 operates in the single-color image generation mode.

The background correction processing unit 341 performs background correction processing for correcting a background level of a document on image information output in the second operating mode. For example, the background correction processing unit 341 uniformly corrects areas of invisible images corresponding to areas of “white” in a visible image to an image level of “white.” Thus, a gray area in invisible image is corrected to the background level of the document.

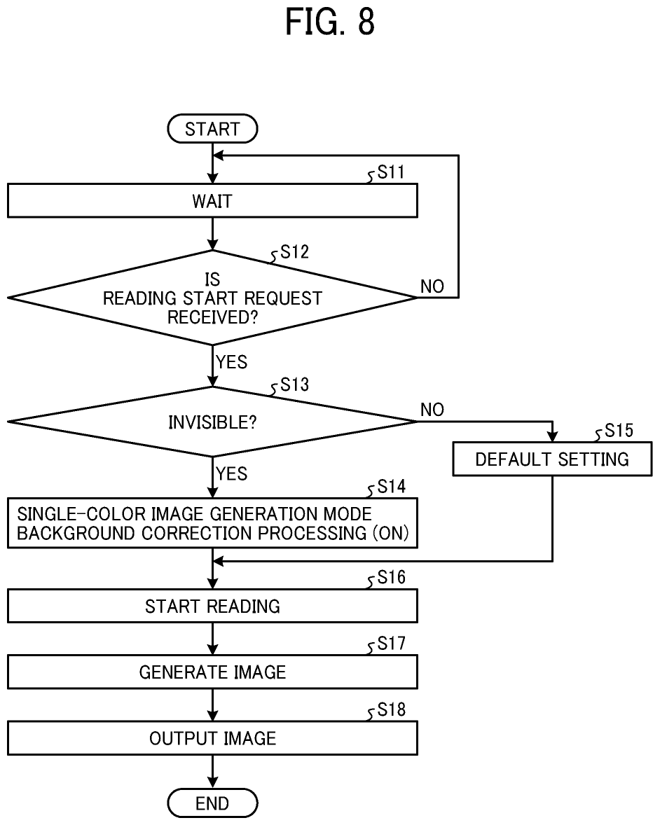

FIG. 8 is a flowchart illustrating an example of an image processing flow performed by the reading device 3 according to Modification 1 of the example.

In a flow illustrated in FIG. 8, background correction processing is added to the flow illustrated in FIG. 4.

Steps S11 to S18 as an overall flow of FIG. 8 correspond to steps S1 to S8 described with reference FIG. 4. In step S14 of FIG. 8, when the switching unit 33 switches the multicolor image generation mode of the image processor 13 to the single-color image generation mode. background correction processing is turned on.

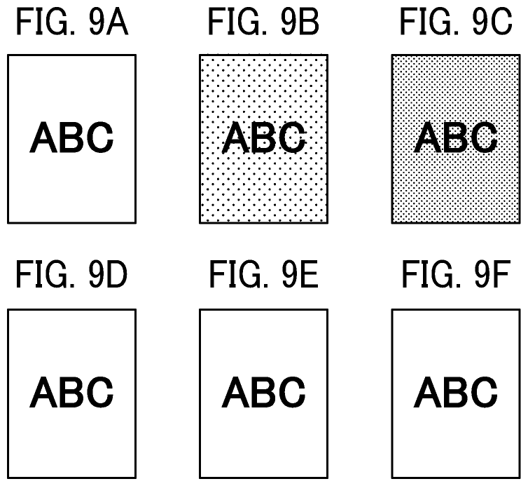

FIG. 9A to FIG. 9F are diagrams illustrating an example of comparison between a case where background correction processing is included and a case where background correction processing is not included.

FIG. 9A, FIG. 9B, and FIG. 9C are examples of output images obtained by reading the paper A, the paper B, and the paper C by the reading device 3 in the second operating mode and outputting the read images without performing the background correction processing. Each of the paper A, the paper B, and the paper C used in this modification has a white background to the naked human eye.

Since the background correction processing is not performed, the difference in reflectance in the infrared wavelength range between the three types of paper appears on the output images of FIG. 9A, FIG. 9B, and FIG. 9C. Accordingly, the densities of the three types of paper are different from each other although the three types of paper have the same or substantially the same white color.

By contrast, FIG. 9D, FIG. 9E, and FIG. 9F are examples of output images obtained by reading the paper A, the paper B, and the paper C by the reading device 3 in the second operating mode and outputting the read images on which the background correction processing is performed. Since the background correction processing is performed, the density difference caused by the difference in reflectance in the infrared wavelength range between the three types of paper is corrected. Accordingly, the color of the background of each of the output images of FIG. 9D, FIG. 9E, and FIG. 9F is white, which is the same color of an original viewed by the naked human eye.

Thus, by performing the background correction processing such as processing of correcting a background area to white, even when different white papers having different reflectances in an invisible light wavelength range are used, the background is unified to white.

Although, in the present modification, the description given of a case in which the background of paper is white, and the image level of the background is unified to white, this is just one example. Alternatively, a density may be changed according to a density of paper or black character information printed on the paper. For example, assuming that black is 0 level and white is 255 level, the image level may be slightly lowered to a level of about 200 to 230. Alternatively, the image level may be further lowered so that the background is corrected to a constant level without degrading the density of black character information or the like, in other words, without degrading visual recognizability.

With the configuration according to Modification 1 as described above, the background correction is performed on an invisible image that is read in the second operating mode. Even in a case that a defined type of paper is not used, an output image that is the same or substantially the same to the naked human eye as an original certificate can be obtained. Thus, such the output image including the invisible image information can be evidence of a stored image including visible information.

### Modification 2 of Example

As modification 2 of the example, a configuration of a reading device having a print correction processing unit that performs image correction suitable for printing is described. In a case where latent image information in a document is read by a reading device using invisible light and an output image obtained by the reading is printed on paper or the like, low density of the latent image information is enough when required density is the one that is visually recognized. However, when the latent image information is a code information, the low density causes an error in reading the code. This requires correction of density. Accordingly, in Modification 2, a configuration is described in which the printing correction processing unit is added so that density correction of latent image information can be performed when the latent image information is to be printed.

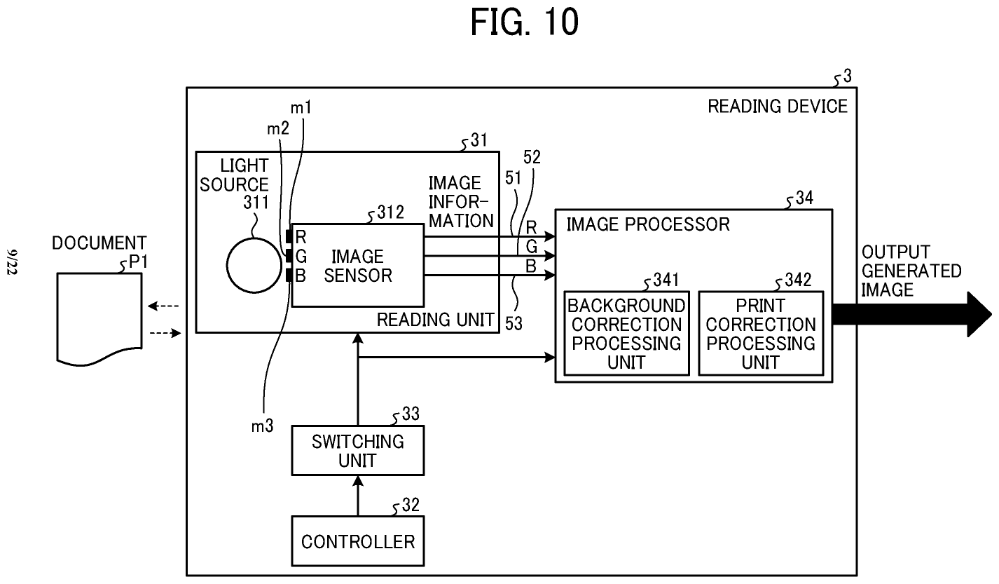

FIG. 10 is a block diagram illustrating an example of a configuration of the reading device 3 according to Modification 2 of the example. As illustrated in FIG. 10, the image processor 34 of the reading device 3 includes a print correction processing unit 342.

Since the image generation mode of the image processor 34 switches from the multicolor image generation mode to the single-color image generation mode, the print correction processing unit 342 operates in the single-color image generation mode.

The print correction processing unit 342 of the image processor 34 performs image correction suitable for printing.

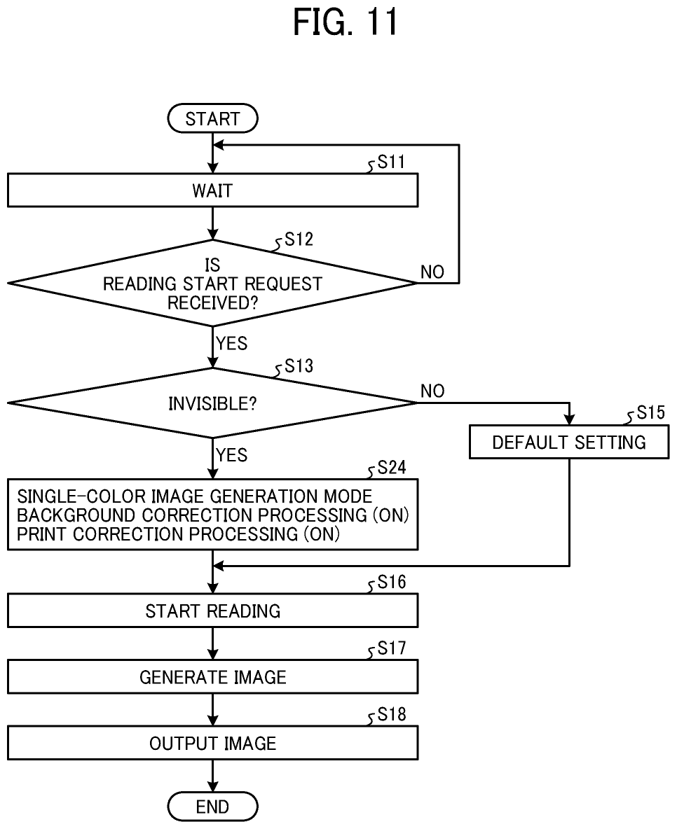

FIG. 11 is a flowchart illustrating an example of an image processing flow performed by the reading device 3 according to Modification 2 of the example. The flow illustrated in FIG. 11 is different from the flow illustrated in FIG. 8 in that print correction processing is added. In step S24 of FIG. 11, the print correction processing is added to the process of step S14.

In step S24, when the switching unit 33 switches the multicolor image generation mode of the image processor 13 to the single-color image generation mode, the print correction processing is further turned on.

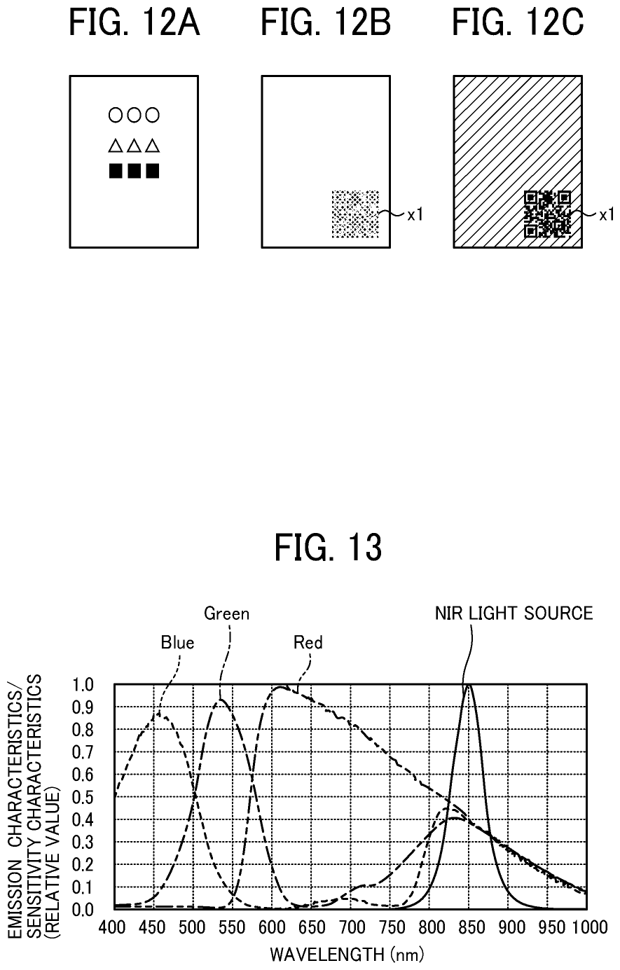

FIG. 12A, FIG. 12B, and FIG. 12C are diagrams for describing the print correction processing. FIG. 12A illustrates a document in which code information is latent with invisible ink. FIG. 12B illustrates an example in which invisible image information obtained by reading the document illustrated in FIG. 12A by the reading device 3 using invisible light is output on paper without performing the print correction processing. In a case that the purpose is only to visually recognize the latent image information, code information x1 that is output at an appropriate density as illustrated in FIG. 12B suffices.

However, when multiple persons use code information printed on paper by reading the code information with their own imaging devices such as mobile cameras, white of a background and black of dots have to be corrected to appropriate levels so that the code information can be recognized by any imaging device, thereby the imaging devices used by the multiple persons can read the code information.

In FIG. 12B, a portion of the code information x1 is 128-level gray, and the other portions are 255-level white. In the image density illustrated in FIG. 12B, when the code information printed on paper is read by the imaging device, it is difficult to recognize the read code information.

By contrast, when the image processor 34 performs the print correction processing, as illustrated in FIG. 12C, the black dots are corrected to high density and the background portion is corrected to low density. This enhances the recognition rate of the code information for each of the mobile cameras used by the multiple persons. In the example illustrated in FIG. 12C, the portion of the code information x1 is corrected to 16-level black, and the other portions are corrected to 200-level white.

As described above, when latent image information is, for example, code information that is to be read by another device, the print correction processing can enhance the recognition rate.

### Modification 3 of Example

Invisible latent image information that is not perceptible to the naked human eye can be embedded by printing on a document using a material exhibiting different absorption and transmission characteristics in a visible light wavelength range and an infrared wavelength range. Since a general-purpose image sensor can read infrared light, the embedded latent image information can be visualized by outputting a single-color image in a reading mode using infrared light. As Modification 3 of the example, a configuration of a reading device in which a near-infrared (NIR) light source is used as the light source 311 is described.

FIG. 13 is a graph illustrating a relation between spectral sensitivity characteristics (FIG. 2) of a typical silicon image sensor and emission profile characteristics of an NIR light source. As illustrated in FIG. 13, silicon forming pixels of a typical image sensor has sensitivity not only in a visible light wavelength range but also in an invisible infrared light range. Further, light emitted from the NIR light source is in an infrared light range and is not perceptible to the naked human eye. By contrast, an image sensor can receive light emitted from the NIR light source and convert the received light to an image. For this reason, it is effective to use a near-infrared light source as invisible light.

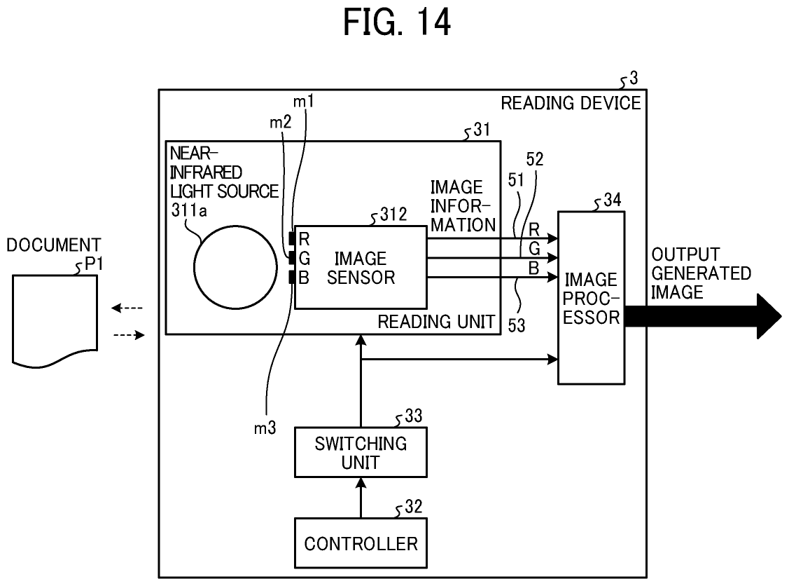

FIG. 14 is a block diagram illustrating an example of a configuration of the reading device 3 according to Modification 3 of the example. As illustrated in FIG. 14, a near-infrared light source 311a is used as the light source 311 of the reading device 3.

In the first operating mode, the image sensor 312 reads the document P1 with pixels of RGB under visible light and outputs multiple pieces of image information for colors of RGB, respectively. In the second operating mode, the document P1 is irradiated with near-infrared light, and the image sensor 312 reads the document P1 in a single color with the pixels of RGB. Also in this case, multiple pieces of monochromatic image information are output for three colors, respectively. Although the multiple pieces of image information respectively corresponding three colors are output in the second operating mode, the image processor 34 is switched to the single-color image generation mode in the second operating mode. Accordingly, for example, image information corresponding to one of the three colors can be output as a monochrome image or the multiple pieces of image information respectively corresponding to the three colors can be adjusted to be monochrome and output. Thus, an image is generated in a manner different from that in the multicolor image generation mode.

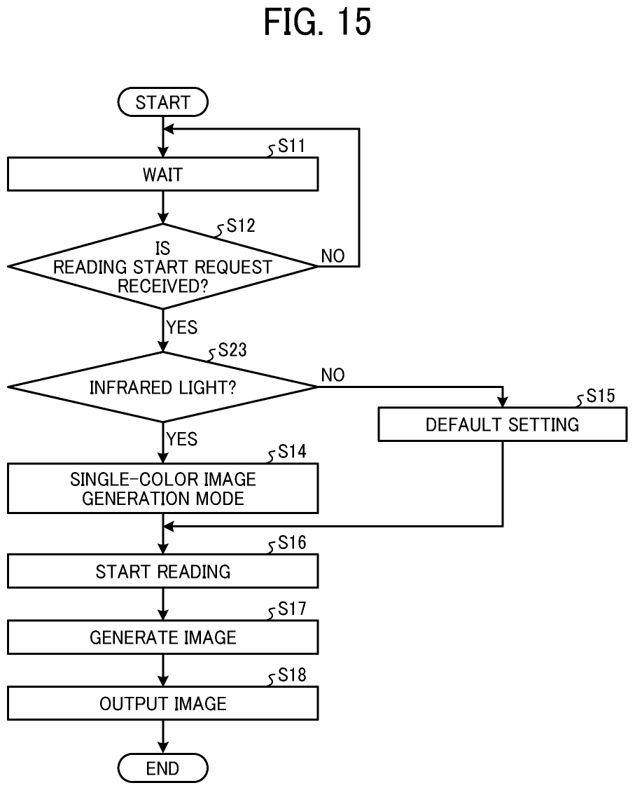

FIG. 15 is a flowchart illustrating an example of an image processing flow performed by the reading device 3 according to Modification 3 of the example. In the flow illustrated in FIG. 15, the process of step S13 of the flow illustrated in FIG. 8 is replaced with determination of an infrared light reading mode (step S23). Although the background correction processing is not included in the example illustrated in FIG. 15, the background correction processing may be included.

As described above, by using a general-purpose image sensor, the same effect can be obtained in a simpler and lower-cost reading device.

### Modification 4 of Example

As Modification 4 of the example, a configuration of the reading device 3 including an infrared (IR) pixel having peak sensitivity in a near-infrared wavelength range in addition to the R pixel, the G pixel, and the B pixel is described.

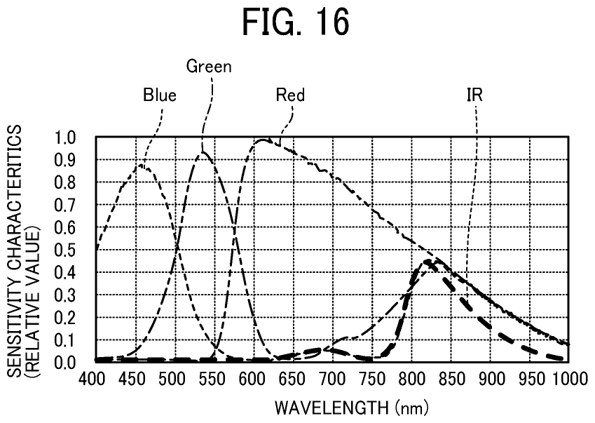

FIG. 16 is a graph illustrating the spectral sensitivity characteristics (FIG. 2) of the R pixel, the G pixel, and the B pixel and spectral sensitivity characteristics of the IR pixel. As illustrated in FIG. 15, the sensitivity of the IR pixel is low in a visible light wavelength range and has a peak in an infrared wavelength range.

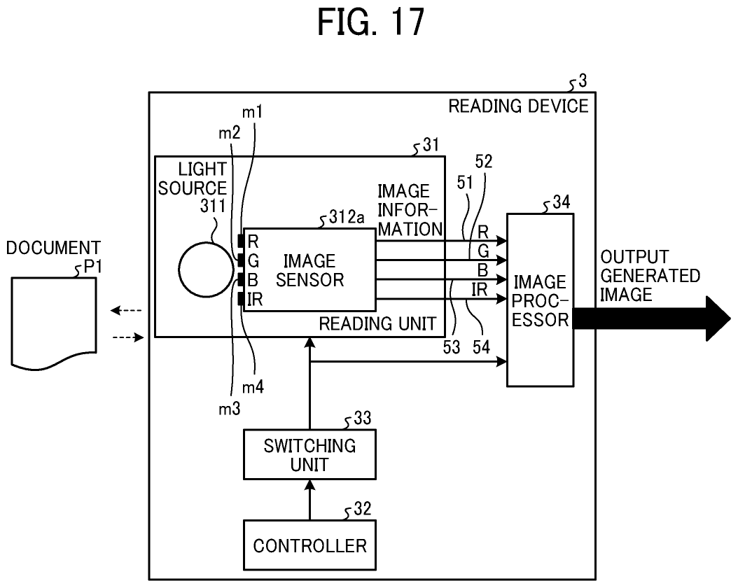

FIG. 17 is a block diagram illustrating an example of a configuration of the reading device 3 according to Modification 4 of the example. As illustrated in FIG. 17, an image sensor 312a of the reading device 3 includes an IR pixel m4 having sensitivity characteristics different from the sensitivity characteristics of the R pixel m1, the G pixel m2, and the B pixel m3. The light source 311 may be a light source including visible light and infrared light provided that it includes light in an infrared wavelength range.

In the first operating mode, the image sensor 312a reads the document P1 with the pixels of RGB (the R pixel m1, the G pixel m2, and the B pixel m3), to output multiple pieces of image information (the R image information 51, the G image information 52, and the B image information 53) respectively corresponding to the RGB colors. In the second operating mode, the image sensor 312a reads the document P1 in monochrome with the IR pixels m4. In the second operating mode, since the image processor 34 is switched to a setting of the single-color image generation mode, image information 54 of the IR pixel m4 can be output as a monochrome image. The image information 54 of the IR pixel m4 corresponds to infrared image information.

With the reading device 3 having the configuration as illustrated FIG. 17, an visible image and an invisible image can be acquired in a single scan, by configuring settings so that the light source 311 are turned on in the first operating mode and the second operating mode, and the R image information 51 read by the R pixel m1, the G image information 52 read by the G pixel m2, the B image information 53 read by the B pixel m3, and the image information 54 read by the IR pixel m4 are output to the image processor 34. The image processor 34 outputs the three pieces of image information respectively corresponding to three colors, i.e., the R image information 51 output from the R pixel m1, the G image information 52 output from the G pixel m2, and the B image information 53 output from the B pixel m3 as a visible image with the setting of the multicolor image generation mode. The image processor 34 outputs the image information 54, which is monochrome image information, output from the IR pixel m4 as a monochrome image with the setting of the single-color image generation mode.

By acquiring a visible image at the same time when acquiring an evidence image for verifying authenticity of the certificate, an original certificate image can also be kept. Currently, a copy of an original document is required for an application at a government office or the like, and an image for checking authenticity is required for response in case of emergency. The configuration of acquiring the original document and the image for checking authenticity at the same time in a single scan enhances convenience.

### Modification 5 of Example

As Modification 5 of the example, a configuration of a reading device that can change a correction level of background correction processing is described.

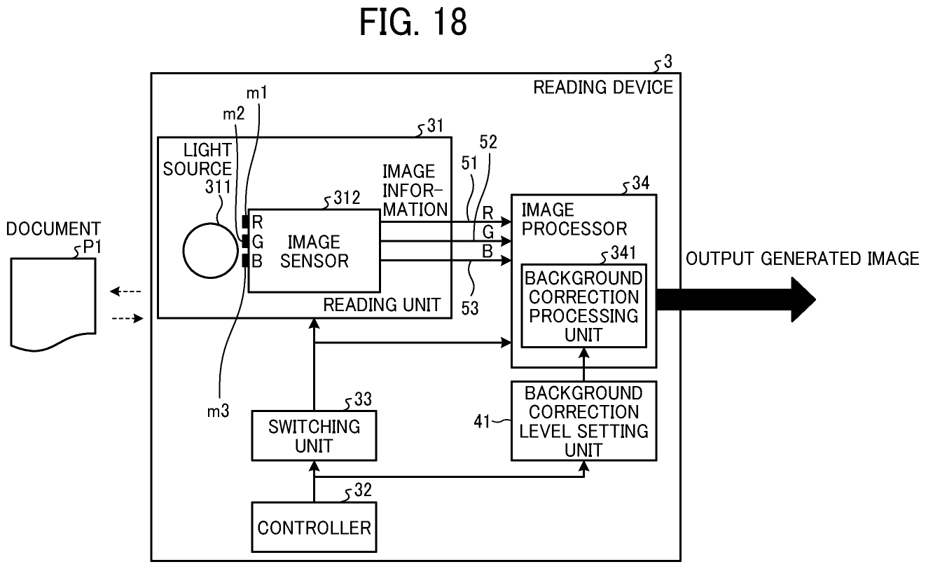

FIG. 18 is a block diagram illustrating an example of the reading device 3 according to Modification 5 of the example. As illustrated in FIG. 18, the reading device 3 according to Modification 5 includes a background correction level setting unit 41 as a “setting unit.”

The background correction level setting unit 41 can be set by the controller 32, and a correction value set in the background correction level setting unit 41 is set in the background correction processing unit 341.

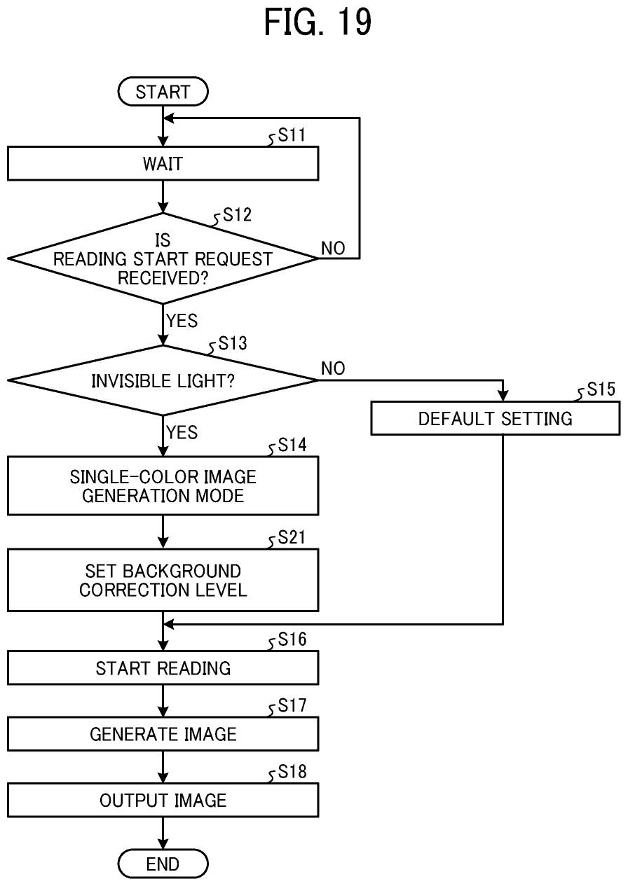

FIG. 19 is a flowchart illustrating an example of an image processing flow performed by the reading device 3 according to Modification 5 of the example. In a flow illustrated in FIG. 19, setting of a background correction level (step S21) is added to the flow illustrated in FIG. 8.

In the second operating mode, a correction value of the background correction level setting unit 41 is set in the background correction processing unit 341 in step S21. After the process of step S21, the reading processing is performed in the second operating mode (step S16), the single-color image generation is performed by the image processor 34, and the background correction processing using the correction value is performed (step S17).

Although the description given above is of a case in which the background correction is not performed in other reading modes than the second operating mode, the background correction may be performed in other reading mode.

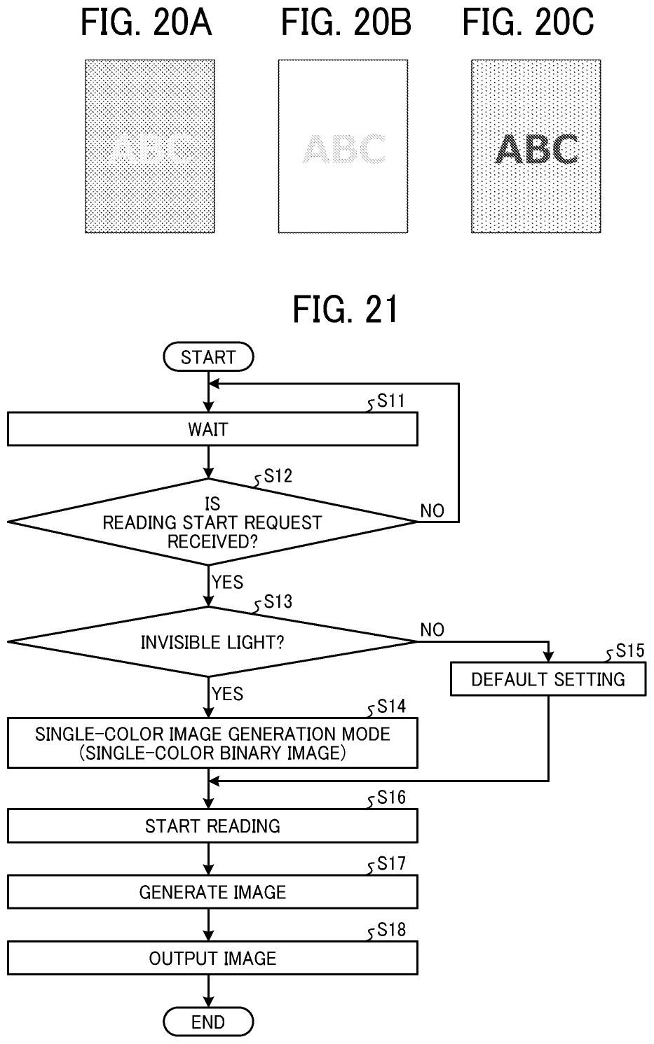

FIG. 20A, FIG. 20B, FIG. 20C are diagrams illustrating an example of comparison between an output image in a case of performing the background correction processing using the correction value and an output image in a case of performing the background correction without using the correction value. FIG. 20A illustrates a document. FIG. 20B illustrates an output image obtained by performing the background correction for an invisible image of the document with a fixed value. FIG. 20C illustrates an output image obtained by performing the background correction for an invisible image of the document with a correction value whose setting is changed.

It is assumed that there is a document on which characters (A, B, and C) are printed with an insufficient application amount of invisible light ink, as illustrated in FIG. 20A. When the background correction processing is applied to such a document to typically correct the background to white as illustrated in FIG. 20B, although latent image information is visualized, an output image is obtained in which the characters “A, B, C” are faint and visual recognizability is poor.

By contrast, as illustrated in FIG. 20C, when the correction level is reset to a slightly lower level, although the background is slightly darker, the density of the characters is increased, thereby visual recognizability is remarkably enhanced. Although the description given above is of a case in which characters are latent image information, when the latent image is code information, poor visual recognizability affects recognition performance. Accordingly, a configuration in which the background correction level is changeable to a desired value produces an effect that latent image information after visualization can be handled in a simple manner.

### Modification 6 of Example

As Modification 6, an operation is described that is performed when the single-color image generation mode is set to single-color binary image generation mode. The single-color image generation mode includes a single-color multilevel image generation mode and a single-color binary image generation mode. The single-color multilevel image generation mode is a mode for generating a single-color multilevel (also referred to as called as “gray scale”) image. The single-color binary image generation mode is a mode for generating a black-and-white binary image.

FIG. 21 is a flowchart illustrating an example of an image processing flow performed by the reading device 3 according to Modification 6 of the example. In a flow illustrated in FIG. 21. a single-color image is set to a single-color binary image in step S14 of the image processing flows described above.

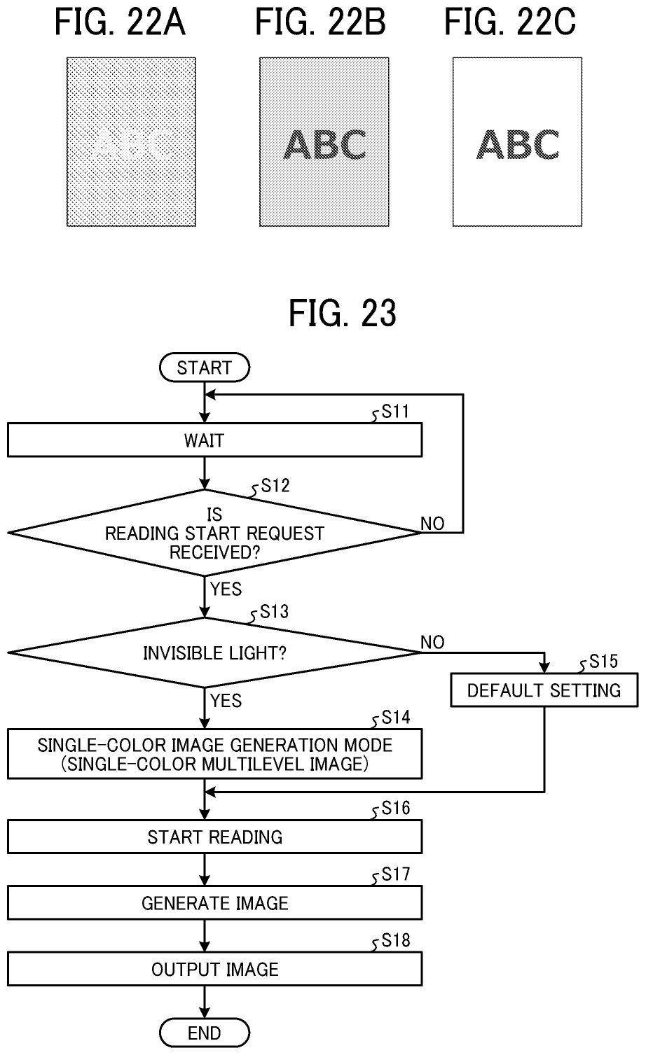

FIG. 22A, FIG. 22B, and FIG. 22C are diagrams illustrating an example of comparison between a single-color multilevel image and a single-color binary image. FIG. 22A illustrates a document. FIG. 22B illustrates an output image in which an invisible image of the document is generated by multiple values. FIG. 22C illustrates an output image in which the invisible image of the document is generated by two values. The output image formed by a multilevel image per pixel and the output image formed by a binary image per pixel are equivalent to each other in that latent image information is visualized. As the image of FIG. 22B, in the case of multiple values, characters and a background are formed as multi-bit information. By contrast, as the image of FIG. 22C, in the case of two values, the image is formed by 1-bit information such that the characters are black and the background is white. For this reason, in the case of the single-color binary image, since the background is white, a large image area can be compressed, a higher compression ratio can be obtained. This can reduce a data amount of the image.

### Modification 7 of Example

As Modification 7, an operation is described that is performed when the single-color image generation mode is set to single-color multilevel image generation mode.

FIG. 23 is a flowchart illustrating an example of an image processing flow performed by the reading device 3 according to Modification 7 of the example. In a flow illustrated in FIG. 23, a single-color image is set to a single-color multilevel image in step S14 of the image processing flows described above.

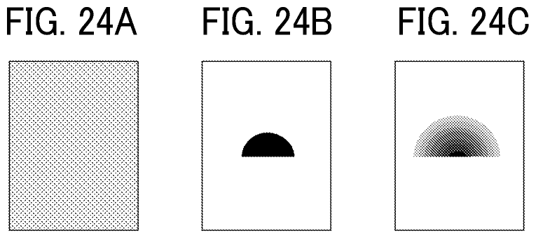

FIG. 24A, FIG. 24B, and FIG. 24C are diagrams illustrating an example of comparison between a single-color multilevel image and a single-color binary image. FIG. 24A illustrates a document. FIG. 24B illustrates an output image in which an invisible image of the document is generated by multiple values. FIG. 24C illustrates an output image in which the invisible image of the document is generated by two values.

With regard to invisible image information in which density itself forms a design or invisible image information in which a difference in density has meaning, such as a logo mark as illustrated in FIG. 24C, an image is not reproduced when generated by two values. To address such a situation, with regard to invisible image information in which density has meaning, image formation is performed in the single-color multilevel image generation mode. Thus, embedded invisible image information is reproduced more faithfully.

### Modification 8 of Example

Control is described that is performed in a case that an image generation mode is switched to a mode such as a default mode, which is a mode other than the single-color image generation mode, after an operation in the single-color image generation mode is completed. With regard to a reading device, a color scan operation or a monochrome scan operation that performs scanning with visible light, or a copy operation is selected in more cases than scanning with invisible light in general offices or public spaces, for example. For this reason, by switching to, for example, a full-color mode or a mode individually set as a default instead of an invisible light scan mode for relatively special usage, convenience for a user is enhanced.

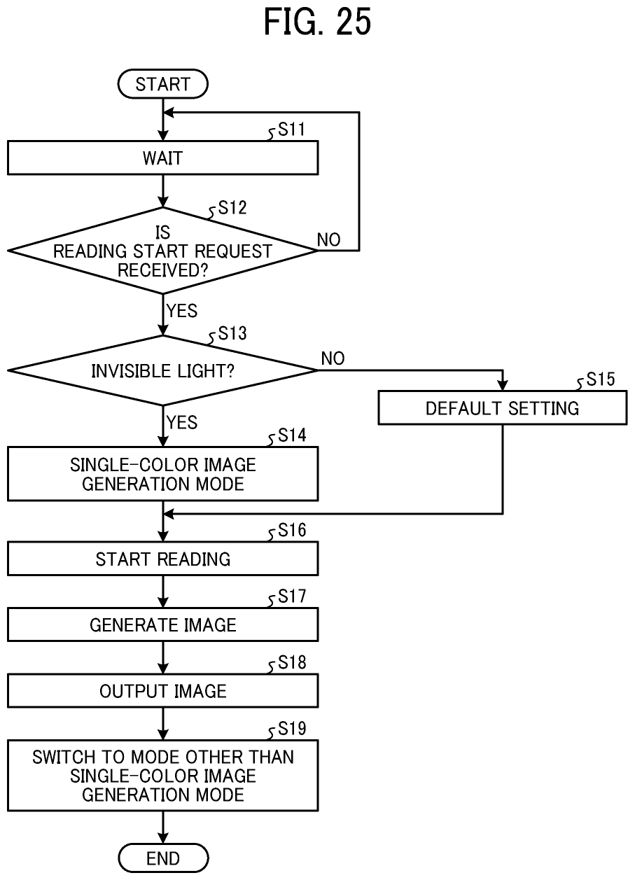

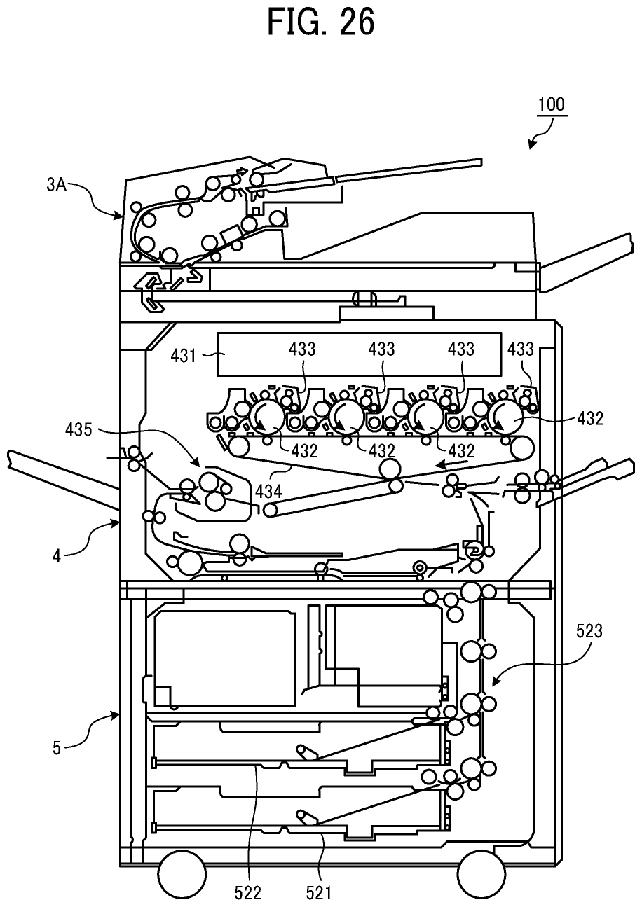

FIG. 25 is a flowchart illustrating an example of an image processing flow performed by the reading device 3 according to Modification 8 of the example. The flow illustrated in FIG. 25 includes a step S19 of switching to a mode other than the single-color image generation mode after outputting an image. Although in the present modification, the description given is of a case in which the mode is switched after the image output, alternatively, the mode may be switched after any other suitable image processing provided that the operation is performed appropriately. Still alternatively, in consideration of a case where reading using invisible light is consecutively performed, a predetermined standby time may be provided between an image output and a mode switching by a timer, for example.

A scanner is often set by default to an automatic color mode in which a document is read and determination is determined as to whether the read document is color or monochrome or a full color mode for convenience. When a document is scanned using invisible light with the default setting unintentionally, an image may be output with unnatural coloring or density processing, which is different from the one perceptible to the naked human eye. This causes the drawback that a user feels strange when the user views the output image. In this case, the document has to be scanned using invisible light with a mode that is reset to a suitable one, this takes time and efforts. Further, in a case where one temporarily keeps a certificate handed over from an owner of the certificate and has to return the certificate to the owner immediately after checking a scan/copy operation, rescanning of the certificate cannot be performed. In the present embodiment, when the second operating mode for generating an image using invisible light is selected, an operating mode is automatically switched to the single-color image generation mode. Accordingly, an image generation mode optimum for an operating mode using invisible light is automatically set without requiring a user to switch the setting, and unnatural coloring of the output image can be prevented. In addition, the image processing apparatus according to the embodiment is switched to the single-color image generation mode, which is most suitable, when an operating mode using invisible light is selected, regardless of whether an object is a moving object or a stationary object, and thus image quality enhanced. Further, scanning and copying are performed with appropriate settings at the time of the first reading. Each of the image processing apparatus 1 and the reading device 3 includes, for example, a central processing unit (CPU) and a memory. The CPU executes a program loaded to the memory, to implement one or more of the controller 11, the switching unit 12, the image processor 13, the controller 32, the switching unit 33, the image processor 34, the background correction processing unit 341, the print correction processing unit 342, and the background correction level setting unit 41. Alternatively, one or more of the controller 11, the switching unit 12, the image processor 13, the controller 32, the switching unit 33, the image processor 34, the background correction processing unit 341, the print correction processing unit 342, and the background correction level setting unit 41 may be implemented by hardware such as an application specific integrated circuit (ASIC).

### Embodiment 2

FIG. 26 is a schematic view illustrating a configuration of an image forming apparatus according to Embodiment 2. In FIG. 26, a copier 100 as an example of the image forming apparatus includes an automatic document feeder (ADF) 3A having a function as the reading device, an image forming section 4, and a sheet feeding section 5.

The sheet feeding section 5 includes sheet trays 521 and 522 and a sheet roller unit 523. Different sizes of recording media are placed on the sheet trays 521 and 522. The sheet roller unit 523 includes a plurality of roller pairs that convey recording media from the sheet trays 521 and 522 to an image forming position at which the image forming section 4 forms images on the recording media.

The image forming section 4 includes an exposure device 431, photoconductor drums 432 each having a drum shape, developing devices 433, a transfer belt 434, and a fixing device 435. The image forming section 4 exposes the photoconductor drums 432 with the exposure device 431 according to image data of a document read by an image reader inside the ADF 3A to form latent images on the photoconductor drums 432 and supplies toner of different colors to the photoconductor drums 432 by the developing devices 433 to develop the latent images on the photoconductor drums 432. The image forming section 4 transfers toner images developed on the photoconductor drums 432 by the transfer belt 434 to a recording sheet supplied from the sheet feeding section 5 and fuses the toners of the toner images transferred to the recording sheet by the fixing device 435 to fix a composite color image to the recording sheet.

Thus, the reading device of the example or the modifications is applicable to the image forming apparatus.

The above-described embodiments are illustrative and do not limit the present invention. Thus, numerous additional modifications and variations are possible in light of the above teachings. For example, elements and/or features of different illustrative embodiments, examples, modifications may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Application No. 2022-073501, filed on Apr. 27, 2022, in the Japan Patent Office, the entire disclosure of which is hereby incorporated by reference herein.

### REFERENCE SIGNS LIST

1 Image processing apparatus
2 Imaging device
11 Controller
12 Switching unit
13 Image processor
21 Light source
22 Image sensor
P Object

1-14. (canceled)

15. An image processing apparatus, comprising:
a light source to irradiate an object with at least invisible light;
an image sensor having sensitivity to a visible light wavelength range and an invisible light wavelength range;
image processing circuitry configured to generate an image according to image information that is output by the image sensor, the image processing circuitry having both a single-color image generation mode in which a single-color image is generated, the single-color image being an image of a single color, and multiple image generation modes, the multiple image generation modes including color image generation mode in which a red, green, and blue (RGB) color image is generated;
a switch to switch the image processing circuitry between the single-color image generation mode and the multiple image generation modes; and
control circuitry configured to control the switch to switch the image processing circuitry to the single-color image generation mode in response to selection of an operating mode in which the invisible light is emitted.

16. The image processing apparatus of claim 15, further comprising:
background correction processing circuitry configured to correct a background level of the image,
wherein when the operating mode in which the invisible light is emitted is selected, the background correction processing circuitry corrects a background level of the single-color image.

17. The image processing apparatus of claim 15, further comprising:
print correction processing circuitry configured to correct a density of the single-color image,
wherein when the operating mode in which the invisible light is emitted is selected, the print correction processing circuitry corrects the density of the single-color image.

18. The image processing apparatus of claim 15, wherein:
the light source that emits the invisible light is a near-infrared light source to emit light in an infrared light range,
the invisible light wavelength range is an infrared wavelength range, and
the image sensor has sensitivity to the infrared wavelength range.

19. The image processing apparatus of claim 15, wherein:
the image sensor includes pixels having a peak sensitivity to an infrared wavelength range, and
the image processing circuitry generates the single-color image according to infrared image information that is output from the image sensor.

20. The image processing apparatus of claim 16, further comprising:
setting circuitry configured to set a correction level of the background correction processing circuitry,
wherein when the setting circuitry changes a setting of the correction level, the background correction processing circuitry corrects the background level of the single-color image with the changed setting.

21. The image processing apparatus of claim 15, wherein:
in the single-color image generation mode, the image processing circuitry generates a black-and-white binary image as the single-color image.

22. The image processing apparatus of claim 15, wherein:
in the single-color image generation mode, the image processing circuitry generates a single-color multilevel image.

23. The image processing apparatus of claim 15, wherein:
the switch switches the image processing circuitry from the single-color image generation mode to a mode different from the single-color image generation mode after the image is generated in the single-color image generation mode.

24. A reading device, comprising:
a scanner including the light source and the image sensor of the image processing apparatus of claim 15.

25. An image forming apparatus, comprising:
a scanner including the light source and the image sensor of the image processing apparatus of claim 15; and
an image forming section to form an image according to an output image output from the image processing circuitry.

26. An image processing method, comprising:
irradiating an object with at least invisible light;
outputting image information of the object from an image sensor having sensitivity to a visible light wavelength range and an invisible light wavelength range;
generating an image according to the image information that is output from the image sensor, the generating having both a single-color image generation mode in which a single-color image is generated, the single-color image being an image of a single color, and multiple image generation modes, the multiple image generation modes including color image generation mode in which a red, green, and blue (RGB) color image is generated; and
switching between the single-color image generation mode and the multiple image generation modes, the switching performing switching to the single-color image generation mode in response to selection of an operating mode in which the invisible light is emitted.

27. A non-transitory computer readable recording medium storing a program including instructions which, when executed by one or more processors of a computer, causes the one or more processors to perform an image processing method, the method comprising:
irradiating an object with at least invisible light;
outputting image information of the object from an image sensor having sensitivity to a visible light wavelength range and an invisible light wavelength range;
generating an image according to the image information that is output from the image sensor, the generating having both a single-color image generation mode in which a single-color image is generated, the single-color image being an image of a single color, and multiple image generation modes, the multiple image generation modes including color image generation mode in which a red, green, and blue (RGB) color image is generated; and
switching between the single-color image generation mode and the multiple image generation modes, the switching performing switching to the single-color image generation mode in response to selection of an operating mode in which the invisible light is emitted.
